(19) United States
(12) Patent Application Publication
(10) Pub. No.: US 2007/0036900 A1
(43) Pub. Date: Feb. 15, 2007

(54) Process for improving the corrosion resistance of a non-stick coating on a substrate

(76) Inventor: Yuqing Liu, Shizuoka (JP)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/493,753

(22) Filed: Jul. 26, 2006

Related U.S. Application Data
(60) Provisional application No. 60/707,591, filed on Aug. 12, 2005.

(51) Int. Cl. B05D 3/02

(52) U.S. Cl. 427/372.2; 427/402

(57) ABSTRACT

The present invention provides a process for improving the corrosion resistance of a non-stick coating on a substrate by applying a base coat to the substrate. The base coat comprises a liquid composition of heat resistant non-fluoropolymer binder and inorganic filler particles wherein the inorganic particles have an average particle size of no greater than about 2 micrometers. The liquid composition is applied to a substrate with a dry film thickness of at least about 10 micrometers, preferably about 10 to about 35 micrometers, and dried to obtain the base coat. A non-stick coating is applied over the base coat. The heat resistant non-fluoropolymer binder is preferably selected from the group consisting of polyimide (PI), polyamideimide (PAI), polyether sulfone (PES), polyphenylene sulfide (PPS) and a mixture thereof. More preferably the non-fluoropolymer binder comprises a polyamideimide having a number average molecular weight of at least about 15,000.

### FIELD OF THE INVENTION

This invention is in the field of improving the corrosion resistance of a non-stick coating on as substrate. In particular, the invention is in the field of producing improved cookware having a non-stick coating thereon, where the coating has improved corrosion resistance and maintains good adhesion to the substrate.

### BACKGROUND OF THE INVENTION

It has long been desirable to produce coated cookware which has an inner cooking surface with good release properties while being resistant to the corrosive affects of detergents and salt containing foods.

Non-stick coatings are well known in the art. In these coatings often fluoropolymer resins are used, since these resins have a low surface energy as well as thermal and chemical resistance. Such polymers produce surfaces that release cooked food items, are cleaned easily, are stain resistant and are useful at cooking and baking temperatures. However, non-stick coatings based solely on fluoropolymer resins have poor adhesion to the metal cookware substrate and limited corrosion resistance.

To improve corrosion resistance, cookware manufacturers have produced saucepans and fry pans made from stainless steel. Stainless steel is a family of steels that is normally considered resistant to corrosion (rusting). These steels contain a quantity of chromium that reacts with air to form an invisible, protective chrome oxide surface layer. However, under exposure to heat and salt, such as present when cooking saliferous (salt containing or salt producing) food items, the chrome oxide layer is damaged permitting salt ion (iron) attack and causing rust formation, i.e., red rust Fe(OH)₃. In more industrial settings, saliferous materials such as dust, gas, and chemicals can induce corrosion on substrates.

However, the adhesion of fluoropolymer coatings to stainless steel and steel is even more challenging than adhesion to the more common aluminum cookware substrates. If the adhesion to the substrate is poor, the salt ion will reach the substrate more easily affecting increased corrosion, even though the integrity of the coating is not affected.

Adhesion can be improved by making the surface of the substrate rougher, for examples, by sand blasting, grinding, acid etching, brushing or forming a roughened layer of metal or ceramic by thermal arc spraying. Other methods of increasing adhesion include forming a primer layer by mixing fluoropolymer resins with heat resistant polymer binder resins and then applying one or more fluoropolymer non-stick overcoats. The heat resistance binder in the primer aids in adhesion to substrate, where the fluoropolymer resin aids in adhesion between the primer and the overcoat layer(s).

Despite the many advances, current non-stick coatings for cookware, especially those produced from stainless steel metal exhibit limited corrosion resistance, even on stainless steel, as evidenced by formation of rust after exposure to 10 wt % boiling salt water for four hours (British Standard BS 7069), such testing simulating the rigors of chemically aggressive food items.

An improved corrosion resistant non-stick coating for metal substrates is desired for use in cookware, electrical appliances, as well as industrial use.

### SUMMARY OF THE INVENTION

The present invention provides a process for improving the corrosion resistance of a non-stick coating on a substrate by applying a base coat to the substrate. The base coat comprises a liquid composition of heat resistant non-fluoropolymer binder and inorganic filler particles wherein the inorganic particles have an average particle size of no greater than about 2 micrometers. The liquid composition is applied to a substrate with a dry film thickness of at least about 10 micrometers, preferably about 10 to about 35 micrometers, and dried to obtain the base coat. A non-stick coating is applied over the base coat. The heat resistant non-fluoropolymer binder is preferably selected from the group consisting of polyimide (PI), polyamideimide (PAI), polyether sulfone (PES), polyphenylene sulfide (PPS) and a mixture thereof. More preferably the non-fluoropolymer binder comprises a polyamide imide having a number average molecular weight of at least about 15,000; preferably in the range of about 15,000 to about 30,000, which molecular weight is greater than what has been previously used in non-stick coating compositions. In a more preferred embodiment, the non-fluoropolymer binder comprises a combination of polyamideimide and polyphenylene sulfide.

The invention further provides for a corrosion resistant composition comprising polyamideimide (PAI) heat resistant polymer binder having a number average molecular weight of at least about 15,000; a liquid solvent, and inorganic filler particles having an average particle size of no greater than about 2 micrometers.

In another embodiment, the invention provides for a corrosion resistant composition comprising liquid solvent, soluble heat resistant non-fluoropolymer binder and insoluble particles of heat resistant non-fluoropolymer binder.

### DETAILED DESCRIPTION OF THE INVENTION

The present invention is a process for obtaining superior corrosion resistance of non-stick coatings on substrates while maintaining the properties of good release and good adhesion. The invention relates to a process for applying to substrates a liquid composition of a heat resistant non-fluoropolymer binder and inorganic filler particles having an average particle size of no greater than about 2 micrometers in order to form a base coat. The base coat has strong adhesion to the substrate.

The heat resistant non-fluoropolymer binder component of the present invention is composed of polymer which is film-forming upon heating to fusion, thermally stable and has a sustained use temperature of at least about 140° C. This component is well known in applications for non-stick finishes, for adhering the fluoropolymer-containing layers to substrates, particularly metal substrates and for film-forming within and as part of the layer. Fluoropolymer by itself has little to no adhesion to a substrate. The binder is generally non-fluorine containing and yet adheres, or is reactive to, a fluoropolymer which is preferably contained in the non-stick coating applied over the base coat. Examples of such polymer binders include one or more: (1) polysulfones, which are amorphous thermoplastic polymers with a glass transition temperature of about 185° C. and a sustained service temperature of about 140° C. to 160° C., (2) polyethersulfones (PES), which are amorphous thermoplastic polymers with a glass transition temperature of about 230° C. and a sustained temperature service of about 170° C. to 190° C., (3) polyimides, polyamide imides (PAI) and/or polyamic acid salt which converts to polyamideimide, which imides crosslink upon heating of the coating to fuse it and have a sustained service temperature in excess of 250° C., among others. The binder is generally non-fluorine containing and yet adheres to a non-stick coating containing fluoropolymer in an over layer. These polymers also adhere well to clean metal surfaces. In a preferred embodiment, such as when using PAI as described below, the binder is soluble in an organic solvent.

One skilled in the art will recognize the possibility of using mixtures of high temperature resistant polymer binders in the practice of this invention. Multiple binders are contemplated for use in this invention, especially when certain properties are desired, such as flexibility, hardness, steam resistance, corrosion resistance and especially sprayability.

Average particle size is defined as a given particle size where, in a given volume of particles, 50% of the total volume of particles have a particle size smaller than or equal to the given particle size, and is defined by the parameter, d₅₀, being equal to the given particle size. For instance, d₅₀=0.15 micrometers means the total volume of the particles whose particle size is smaller than or equal to 0.15 micrometers is 50%. Particle size is defined as a given particle size where, in a given volume of particles, 100% of the total volume of particles have a particle size smaller than or equal to the given particle size, and is defined by the parameter d₁₀₀ being equal to the given particle size. For instance, d₁₀₀=0.30 micrometers means the total volume of the particles whose particle size is smaller than or equal to 0.30 micrometers is 100%, in other words all the particles are smaller or equal to 0.30 micrometers.

In one preferred embodiment, polyphenylene sulfide (PPS) which is insoluble in organic liquids is added as insoluble powder particles to the solution of polymer binder. Polyphenylene sulfides (PPS) are partially crystalline polymers with a melting temperature of about 280° C. and a sustained temperature service of about 200° C. to 240° C. According to the present invention, the particles have an average particle size d₅₀ in the range of from about 5 micrometers to about 20 micrometers. Particularly useful are PPS powder particles having an average particle size (d₅₀) of 10 micrometers with a d₁₀₀ of 42 micrometers. Addition of PPS particles aids in spraying a liquid solution of polymer binder. In particular, when particles of PPS are added to a solution of high molecular weight PAI for application to substrates, improved sprayability is recognized for this high viscosity composition. This is in contrast to controlling the PAI viscosity by simple dilution which tends to result in sagging of the coating upon application. In a preferred embodiment the non-fluoropolymer binder comprises a mixture of PAI in solution and insoluble PPS powder particles, preferably the PAI is present in a greater amount than the PPS based on weight % solids. In a most preferred embodiment, the heat resistant non-fluoropolymer binder comprises a mixture of PAI in solution and insoluble PPS powder particles, wherein PPS powder particles are present in an amount of less than 30 wt % total solids of a liquid composition comprising polymer binder in solution, inorganic filler and PPS powder particles, more preferably less than 10 wt %. For use in this invention, the preferred ratio of PAI:PPS in wt % solids is in the range of 80:20 to 30:70.

The liquid used in this invention is preferably an organic solvent which dissolves the high temperature resistant polymer binder, i.e., the predominant liquid present in the coating composition is organic solvent. Such solvents include N-methylpyrrolidone (NMP), dimethylformamide, dimethylacetamide, dimethylsulfoxide, and cresylic acid, which will depend on the particular polymer binder being used. NMP is a preferred solvent because of its relative safety and environmental acceptability. One skilled in the art will recognize that mixtures of solvents can be used. Organic solvent avoids the creation of rust on the cleaned and grit-blasted substrate.

An example of a preferred binder is polyamide imide (PAI) dissolved into a coalescing agent such as N-methylpyrolidone prior to adding the inorganic filler. In a preferred embodiment, the polyamideimide has a number average molecular weight of at least about 15,000; preferably in the range of about 15,000 to about 30,000; and more preferably from about 18,000 to about 25,000. Higher molecular weight PAI affords the production of thicker films of base coat, i.e., at least about 10 micrometers dried film thickness (DFT). High molecular weight polyamide imide is available from Hitachi Chemical. PAI, of this molecular weight, is typically used for electrical wire but has not previously been used in non-stick coatings for cookware. Higher number average molecular weight of PAI in the base coat is correlated with the ability to form thicker coatings without the occurrence of bubble formation as will be described below and illustrated in the examples.

As noted above, fluoropolymers have a low surface energy and do not adhere well to substrates. To achieve better adhesion to the substrate, especially stainless steel, the liquid composition used in this invention to form the base coat is preferably essentially free of fluoropolymer. Essentially free of fluoropolymer means that the compositions employed contain less than about 0.5 weight % total solids of such fluoropolymers. The inorganic filler particles used in this invention have an average particle size d₅₀ of no greater than about 2 micrometers, preferably no greater than 1 micrometer, more preferably in the range of about 0.1 to about 2 micrometers. The filler particle size is a volume distribution particle size d₅₀ determined using a Helos & Rodos Laser Diffraction Analyser available from SYMPATEC GmbH (Germany). The filler particles prevent shrinkage of the base coat upon drying and baking. Much like the PPS particles described above, the filler particles also aid in viscosity reduction in compositions having the same % solids and therefore sprayability of the liquid composition. The particle size range of the filler particles is critical. Larger filler particles improve sprayability but smaller size particles lead to improved corrosion resistance. The inorganic filler particles are preferably selected from a group of inorganic nitrides, carbides, borides and oxides and mixtures thereof. Examples of filler particles that are useful include oxides of titanium, aluminum, zinc, and tin; inorganic carbides such as silicon oxide; and mixtures thereof. Especially preferred are small particles of TiO₂ due to their ready availability at a reasonable price. In one embodiment, the liquid composition used in this invention to form the base coat contains heat resistant polymer binder and no greater than about 80 wt %, preferably no greater than 50 wt % total solids of inorganic filler particles, and more preferably 20 wt % solids to 70 wt % solids of inorganic filler particles.

The compositions of the present invention can be applied to substrates by conventional means. Spray and roller applications are the most convenient application methods, depending on the substrate being coated. Other well-known coating methods including dipping and coil coating are suitable.

The substrate is preferably a metal for which corrosion resistance is increased by the application of a base coat followed by a non-stick coating. Examples of useful substrates include aluminum, anodized aluminum, carbon steel, and stainless steel. As noted above, the invention has particular applicability to stainless steel. Because stainless steel exhibits poor heat distribution properties, cooking pans are often constructed from multi-plies of aluminum and stainless steel, the aluminum providing more even temperature distribution to the cooking pan and the stainless steel providing a corrosion resistant cooking surface.

The process for coating a substrate by the present invention comprises:

(a) applying to said substrate a liquid composition comprising a heat resistant non-fluoropolymer binder and inorganic filler particles having an average particle size d₅₀ of no greater than about 2 micrometers to said substrate to obtain a base coat having a dry film thickness of at least about 10 micrometers,

(b) drying said composition to obtain said base coat, and

(c) applying said non-stick coating to said base coat to form a coated substrate.

The process may further include baking said coated substrate.

In greater detail, prior to applying the liquid composition, the substrate is preferably cleaned to remove contaminants and grease which might interfere with adhesion. In a preferred embodiment the substrate is then grit-blasted. The cleaning and/or grit-blasting steps enable the base coat to better adhere to the substrate. Conventional soaps and cleansers can be used for cleaning. The substrate can be further cleaned by baking at high temperatures in air, temperatures of 800° F. (427° C.) or greater. The cleaned substrate is then grit blasted, with abrasive particles, such as sand or aluminum oxide, to form a roughened surface to which the base coat can adhere. The roughening that is desired for base coat adhesion can be characterized as a roughness average of 40-160 microinches (1-4 micrometers).

In a preferred embodiment the base coat is applied by spraying. The base coat is applied to a dried film thickness DFT of greater than about 10 micrometers, preferably greater than about 12 micrometers and in other embodiments in ranges of about 15 to about 30 micrometers; and about 18 to about 22 micrometers. The thickness of the base coat affects the corrosion resistance. If the base coat is too thin, the substrate will not be fully covered resulting in reduced corrosion resistance. If the base coat is too thick, the coating will crack or form bubbles resulting in areas that will allow salt ion attack and therefore reduce corrosion resistance. The liquid composition is applied and then dried to form a base coat. Drying temperature will vary based on the composition from 120° C. to 250° C., but for example may be typically 150° C. for 20 minutes or 180° C. for 10 minutes.

After the base coat is applied and dried, conventional non-stick coatings can be applied preferably in the form of a primer and a top coat and may include one or more intermediate coats. One preferred multilayer coating includes a primer (8-15 micrometers), an intermediate layer (8-15 micrometers) and a top coat (5-15 micrometers). The non-stick coating may be any suitable non-stick composition e.g., silicone or fluoropolymers. Fluoropolymers are especially preferred. After the application of the non-stick coating, the substrate is baked. In one preferred embodiment with the 3 layer non-stick fluoropolymer coating the substrate is baked at 427° C. for 3-5 minutes, but baking times will be dependent on the composition and thickness of the non-stick coating.

The fluoropolymers used in the non-stick coatings for use in this invention can be a non melt-fabricable fluoropolymer with a melt viscosity of at least 1×10⁷ Pa·s. One embodiment is polytetrafluoroethylene (PTFE) having a melt viscosity of at least 1×10⁸ Pa·s at 380° C. with the highest heat stability among the fluoropolymers. Such PTFE can also contain a small amount of comonomer modifier which improves film-forming capability during baking (fusing), such as perfluoroolefin, notably hexafluoropropylene (HFP) or perfluoro(alkyl vinyl) ether, notably wherein the alkyl group contains 1 to 5 carbon atoms, with perfluoro(propyl vinyl ether) (PPVE) being preferred. The amount of such modifier will be insufficient to confer melt-fabricability to the PTFE, generally being no more than 0.5 mole %. The PTFE, also for simplicity, can have a single melt viscosity, usually at least 1×10⁹ Pa·s, but a mixture of PTFEs having different melt viscosities can be used to form the non-stick component.

The fluoropolymers can also be melt-fabricable fluoropolymer, either combined (blended) with the PTFE, or in place thereof. Examples of such melt-fabricable fluoropolymers include copolymers of TFE and at least one fluorinated copolymerizable monomer (comonomer) present in the polymer in sufficient amount to reduce the melting point of the copolymer substantially below that of TFE homopolymer, polytetrafluoroethylene (PTFE), e.g., to a melting temperature no greater than 315° C. Preferred comonomers with TFE include the perfluorinated monomers such as perfluoroolefins having 3-6 carbon atoms and perfluoro(alkyl vinyl ethers) (PAVE) wherein the alkyl group contains 1-5 carbon atoms, especially 1-3 carbon atoms. Especially preferred comonomers include hexafluoropropylene (HFP), perfluoro(ethyl vinyl ether) (PEVE), perfluoro(propyl vinyl ether) (PPVE) and perfluoro(methyl vinyl ether) (PMVE). Preferred TFE copolymers include FEP (TFE/HFP copolymer), PFA (TFE/PAVE copolymer), TFE/HFP/PAVE wherein PAVE is PEVE and/or PPVE and MFA (TFE/PMVE/PAVE wherein the alkyl group of PAVE has at least two carbon atoms). The molecular weight of the melt-fabricable tetrafluoroethylene copolymers is unimportant except that it be sufficient to be film-forming and be able to sustain a molded shape so as to have integrity in the undercoat application. Typically, the melt viscosity will be at least 1×10² Pa·s and may range up to about 60-100×10³ Pa·s as determined at 372° C. according to ASTM D-1238. A preferred composition is a blend of non melt-fabricable fluoropolymer with a melt viscosity in the range from 1×10⁷ to 1×10¹¹ Pa·s and melt fabricable fluoropolymer with a viscosity in the range from 1×10³ to 1×10⁵ Pa·s.

The fluoropolymer component is generally commercially available as a dispersion of the polymer in water, which is the preferred form for the composition of the invention for ease of application and environmental acceptability. By “dispersion” is meant that the fluoropolymers particles are stably dispersed in the aqueous medium, so that settling of the particles does not occur within the time when the dispersion will be used. This is achieved by the small size of the fluoropolymer particles, typically on the order of 0.2 micrometers, and the use of surfactant in the aqueous dispersion by the dispersion manufacturer. Such dispersions can be obtained directly by the process known as dispersion polymerization, optionally followed by concentration and/or further addition of surfactant.

Useful fluoropolymers also include those commonly known as micropowders. These fluoropolymers generally have a melt viscosity 1×10² Pa·s to 1×10⁶ Pa·s at 372° C. Such polymers include but are not limited to those based on the group of polymers known as tetrafluoroethylene (TFE) polymers. The polymers may be directly polymerized or made by degradation of higher molecular weight PTFE resins. TFE polymers include homopolymers of TFE (PTFE) and copolymers of TFE with such small concentrations of copolymerizable modifying comonomers (<1.0 mole percent) that the resins remain non-melt-processible (modified PTFE). The modifying monomer can be, for example, hexafluoropropylene (HFP), perfluoro(propyl vinyl) ether (PPVE), perfluorobutyl ethylene, chlorotrifluoroethylene, or other monomer that introduces side groups into the molecule.

Further in accordance with the present invention, the corrosion resistant composition may comprise a liquid organic solvent, a soluble heat resistant non-fluoropolymer binder as described above and insoluble particles of heat resistant non-fluoropolymer binder.

Also in accordance with the present invention there is provided a corrosion resistant composition comprising polyamideimide (PAI) heat resistant polymer binder having a number average molecular weight of at least 15,000, a liquid solvent, and inorganic filler particles having an average particle size of no greater than about 2 micrometers.

An especially useful non-stick coating system is described in EP 1 016 466 B1 and is described more fully in the examples of this application.

As will be shown in the examples, coating systems that do not use the process of applying a base coat, particularly on stainless steel substrates in accordance with the principles of this invention, show reduced corrosion resistance by rust formation and blistering after just four hours of being subjected to British standard BS 7069 (10 wt % salt in boiling water). Whereas, stainless steel substrates prepared according to the process of this invention can with stand rust formation and blistering for at least 24 hours, preferably at least 40 hours, more preferably at least 56 hours, for as long as more than 80 hours under the same conditions.

Products having corrosion resistant non-stick finishes made using the process and compositions of the present invention include fry pans, sauce pans, bakeware, rice cookers and inserts therefor, electrical appliances, iron sole plates, conveyors, chutes, roll surfaces, cutting blades, processing vessels and the like.

### TEST METHODS

Corrosion Resistance Test (British Standard BS 7069)

Corrosion resistance is determined by BS 7069, with the following alterations as noted. Test specimens are prepared as indicated in the examples by cleaning and grit blasting stainless steel pans (SS#304), coating the pans and baking the pans to form the coatings. Salt water solution containing 10 wt % salt is placed in clean test pans to a level past the midway point of the side wall of the pan. The initial water level of the vessel is marked on the side wall of the pan. The pan is placed on a heat source and boiled for 8 hour intervals, instead of the 24 hours stipulated in BS 7069. Deionized water is added to maintain the water level within 15 mm of the water mark at all times. At the end of 8 hours the specimen is washed in warm water using dish detergent to remove adhering salts. The test specimens are visually examined for defects. The process is then repeated.

Adhesion Test (Peeling Test)

Test panels of 304 SS having a dimension of 10×5×1 mm are cleaned, grit blasted, coated and baked as described in the following examples and immersed in boiling water. The water is allowed to come to a full boil after inserting the coated panel, before timing is begun. After the boiling water treatment, the panel is cooled to room temperature without quenching and dried thoroughly. Parallel cuts are made through the dried film coating on the panel at 10 mm intervals. At a 90 degree angle with a peel rate of about 50 mm/min, the force to remove the film is determined and is a measure of the adhesive strength of the film to the metal substrate.

Bubble Formation Test

Long test panels of 304 SS having a dimension of 30×10×1 mm are cleaned and grit blasted. The base coat is applied to the panels with gradually increasing thickness in the length direction. The thickness covers the thickness range from 15 to 40 micrometers. The coated film is observed through a microscope at 40×magnification to determine the place where bubble formation first occurs as the thickness of the coating is gradually increased. Where bubble formation is observed, a thickness measurement is determined. The test determines how thick a base coat can be applied without experiencing bubble formation deleterious to corrosion resistance.

### EXAMPLES

Base coat ingredients:

Soluble polymer binder is Polyamide imide HPC-5000 having a number average molecular weight of about 20,000 and available from Hitachi Chemical, Tokyo, Japan.

Filler particles are titanium dioxide R-900 having an average particle size, d₅₀, of 0.15 and a particle size, d₁₀₀, of 0.30 and available from DuPont Taiwan. Particle size as determined on a Heloe & Rodos Laser diffraction KA/LA analyzer available from SYMPATEC GmbH Germany.

Insoluble polymer binder particles are polyphenylene sulfide (PQ-208) having an average particle size of 10 micrometers and available from Dainippon Ink and Chemicals, Inc. (Tokyo, Japan).

TABLE 1
Base Coat

| Ingredients | Weight (%) | Solid (%) |
|---|---|---|
| N-Methyl pyrolidone | 5.77 | |
| Xylene | 14.90 | |
| Polyamide imide | 53.45 | 40.00 |
| Melamine resin | 0.64 | |
| Polyacylic resin | 1.19 | |
| TiO₂ | 20.04 | 50.00 |
| Polyphenylene Sulfide | 4.01 | 10.00 |
| Total | 100.00 | 100.00 |

Non-stick Coating EP 1 016 466 B1 (Primer, Intermediate Layer, Top Coat) Ingredients:
Fluoropolymer

PTFE dispersion: DuPont TFE fluoropolymer resin dispersion grade 30, available from the DuPont Company, Wilmington, Del.

FEP dispersion: TFE/HFP fluoropolymer resin dispersion with a solids content of from 54.5-56.5 wt % and RDPS of from 150-210 nanometers, the resin having an HFP content of from 9.3-12.4 wt % and a melt flow rate of 11.8-21.3 measured at 372° C. by the method of ASTM D-1238 modified as described in U.S. Pat. No. 4,380,618.

PFA dispersion: DuPont PFA fluoropolymer resin dispersion grade 335, available from the DuPont Company, Wilmington, Del.

Polymer Binder

PAI is Torlon® AI-10 poly(amide-imide) (Amoco Chemicals Corp.), a solid resin (which can be reverted to polyamic salt) containing 6-8% of residual NMP and having a number average molecular weight of approximately 12,000.

Polyamic acid salt is generally available as polyamic acid having an inherent viscosity of at least 0.1 as measured as a 0.5 wt % solution in N,N-dimethylacetamide at 30° C. It is dissolved in a coalescing agent such as N-methyl pyrrolidone, and a viscosity reducing agent, such as furfuryl alcohol and reacted with tertiary amine, preferably triethyl amine to form the salt which is soluble in water, as described in greater detail in U.S. Pat. No. 4,014,834 (Concannon).

Inorganic Film Hardener

Silicon carbide supplied by Elektroschmelzwerk Kempten GmbH (ESK), Munich Germany

P 600=25.8±1 micrometers average particle size

P 400=35.0±1.5 micrometers average particle size

P 320=46.2±1.5 micrometers average particle size

The average particle size is measured by sedimentation using FEPA-Standard-43-GB 1984R 1993 resp. ISO 6344 according to information provided by the supplier.

Aluminum oxide (small particles) are Ceralox HPA0.5 supplied by Condea Vista Co. average particle size 0.35-0.50 micrometers.

TABLE 2
Primer Composition

| Ingredients | Weight Percent |
|---|---|
| PAI-1 | 4.28 |
| Water | 59.35 |
| Furfuryl Alcohol | 3.30 |
| Diethylethanolamine | 0.60 |
| Triethylamine | 1.21 |
| Triethanolamine | 0.20 |
| N-Methylpyrrolidone | 2.81 |
| Furfuryl Alcohol | 1.49 |
| Surfynol 440 surfactant | 0.22 |
| SiC P400 | 3.30 |
| SiC P600 | 3.30 |
| SiC P320 | 1.66 |
| PTFE (solids in aqueous dispersion) | 3.86 |
| Alkylphenylethoxy surfactant | 1.59 |
| FEP (solids in aqueous dispersion) | 2.65 |
| Ludox AM polysilicate | 0.87 |
| Ultramarine blue pigment | 1.63 |
| Carbon black pigment | 0.28 |
| Alumina 0.35-0.50 micrometers | 7.40 |
| Total | 100 |

% solids = 30.4

TABLE 3
Intermediate layer

| Ingredients | Weight Percent |
|---|---|
| PTFE (solids in aqueous dispersion) | 33.80 |
| Nonylphenolpolyethoxy nonionic surfactant | 3.38 |
| Water | 34.82 |
| PFA (solids in aqueous dispersion) | 6.10 |
| Octylphenolpolyethoxy nonionic surfactant | 2.03 |
| Mica Iriodin 153 from MERCK | 1.00 |
| Ultramarine blue pigment | 0.52 |
| Alumina 0.35-0.50 micrometers | 2.39 |
| Triethanolamine | 5.87 |
| Cerium octoate | 0.57 |
| Oleic acid | 1.21 |
| Butylcarbitol | 1.52 |
| Solvesso 100 hydrocarbon | 1.90 |
| Acrylic resin | 4.89 |
| Total | 100 |

TABLE 4
Top coat

| Ingredients | Weight Percent |
|---|---|
| PTFE (solids in aqueous dispersion) | 40.05 |
| Nonylphenolpolyethoxy nonionic surfactant | 4.00 |
| Water | 35.56 |
| PFA (solids in aqueous dispersion) | 2.11 |
| Octylphenolpolyethoxy nonionic surfactant | 1.36 |
| Mica Iriodin 153 from MERCK | 0.43 |
| Cerium octoate | 0.59 |
| Oleic acid | 1.23 |
| Butylcarbitol | 1.55 |
| Triethanolamine | 5.96 |
| Solvesso 100 hydrocarbon | 1.94 |
| Acrylic resin | 5.22 |
| Total | 100 |

### Example 1

A base coat of high molecular weight polyamide imide, PPS and TiO₂ as described in Table 1 is applied by spraying pans and panels of stainless steel #304 that have been washed to remove grease and then grit blasted. The ratio of binder (PAI+PPS)/TiO₂ is 50/50. The dried coating thickness (DFT) of the applied base coat is varied from 8 to 36 microns as shown in Table 4. The baked coating thickness is measured with a film thickness instrument, e.g., Isoscope, based on the eddy-current principle (ASTM B244).

This base coat is permitted to dry by forced air drying at 150° C. for 20 minutes. A non-stick coating is applied similar to the coating described in EP 1 016 466 B1 as follows. A primer coating containing heat resistant polymer binder, fillers and pigments is sprayed over the base coat. The composition for the primer is listed in Table 2. Note that the molecular weight of the polymer binder, filler type and particle size of base coat and primer are different. The intermediate layer is then sprayed over the dried primer. The top coat is applied wet on wet to the intermediate layer. The compositions of the intermediate layer and the top coat are listed in Tables 3 and 4 respectively. The coated substrate is baked at 427° C. for 3-5 minutes. The dried coating thicknesses (DFT) for primer/intermediate layer/top coat are determined from eddy current analysis to be 17 micrometers/15 micrometers/7 micrometers.

The pans are subjected to corrosion resistance testing as explained above under Test Methods. The panels are subjected to adhesion peel testing as described above under Test Methods. Results are listed in Table 5. Base coating thickness is critical to achieving good corrosion resistance.

TABLE 5
Adhesion/Corrosion with varying film thickness

| | Thickness of base coat (micrometers) | | | | | | | | |
|---|---|---|---|---|---|---|---|---|---|
| | 8 | 12 | 15 | 18 | 22 | 25 | 28 | 31 | 36 |
| Adhesion (Kg/cm) | >3 | >3 | >3 | >3 | >3 | >3 | >3 | 2 | <1 |
| Pass BS test (hours) | 4 | 20 | 30 | >80 | >80 | >80 | >80 | 30 | 10 |

### Comparison Example A

Similar to Example 1, a non-stick coating with same primer/intermediate layer/top coat is applied to a stainless steel panel and a stainless steel pan (#304) prepared in the same manner but without the base coat. The panel is subjected to adhesion testing. The pan is subjected to corrosion resistance testing. Adhesion is 2.0 Kgf/cm. Corrosion resistance is only 4 hours.

### Example 2

As described in Example 1, stainless steel panels and pans are prepared and coated with base coat and non-stick coating (primer/intermediate layer/top coat). The ratio between binder polymer (PAI and PPS) and filler is varied according to Table 6. The panels and pans are subjected to adhesion tests and corrosion resistance tests with the results presented in Table 6. Better corrosion resistance and better adhesion is correlated with higher amounts of binder in the base coat.

TABLE 6
Adhesion/Corrosion with varying amounts of binder

| | Binder (PAI + PPS):TiO₂ | | | | | | |
|---|---|---|---|---|---|---|---|
| Test items | 20:80 | 30:70 | 40:60 | 50:50 | 60:40 | 70:30 | 80:20 |
| Adhesion (Kg/cm) | 2 | 3 | >3 | >3 | >3 | >3 | >3 |
| Pass BS test (hours) | 8 | 15 | 40 | 80 | >80 | >80 | >80 |

### Example 3

Longer stainless steel panels (30×10×1) are prepared in a similar way to Example 1 and coated with base coat. The molecular weight of the soluble polymer binder (PAI) is varied according to Table 7. The amount of PPS remains constant and the ratio of binder to filler remains constant. The base coat is applied to the panels with gradually increasing thickness in the length direction. The thickness covers the thickness range from 15 to 40 micrometers. The panels are subjected to the bubble formation test described under Test Methods. The results are presented in Table 7.

Higher number average molecular weight of PAI in the base coat is correlated with the ability to form thicker coatings without the occurrence of bubble formation.

TABLE 7
Bubble Formation with varying molecular
weight of polymer binder in base coat

| | Number average molecular weight | | |
|---|---|---|---|
| Test item | 12,000 | 17,000 | 20,000 |
| Bubbles appear thickness | 6 | 12 | 35 |
| (micrometers) | | | |

### Example 4

As described in Example 1, stainless steel panels and pans are prepared and coated with base coat and non-stick coating (primer/intermediate layer/top coat). The filler size is varied as shown in Table 8. The ratio of binder (PAI+PPS)/TiO₂ is 50/50. The panels and pans are subjected to adhesion tests and corrosion resistance tests with the results presented in Table 9. Better corrosion resistance is correlated with smaller particle size of the inorganic filler in the base coat.

TABLE 8
Fillers/Particle size measurement

| Filler | d₅₀ (micrometers) | d₁₀₀ (micrometers) |
|---|---|---|
| TiO₂ | 0.15 | 0.30 |
| Al2O₃ | 1.02 | 3.00 |
| BaSO₄ | 5.00 | 10.00 |

Particle size for various inorganic filler is determined using Helos & Rodos Laser Diffraction Analyser available from SYMPATEC Gmbh Germany.
d_{50=0.15} micrometers means the total volume of the particles whose particle size is smaller than or equal to 0.15 micrometers is 50%.

d₁₀₀=0.30 micrometers means the total volume of the particles whose particle size is smaller than or equal to 0.30 micrometers is 100%, in other words all the particles are smaller or equal to 0.30 micrometers.

TABLE 9
Adhesion/Corrosion Resistance with varying filler particle size

| | Binder | Binder | Binder |
|---|---|---|---|
| | (PAI + | (PAI + | (PAI + |
| Test items | PPS) + TiO₂ | PPS) + Al₂O₃ | PPS) + BaSO₄ |
| Adhesion (Kg/cm) | >3 | >3 | >3 |
| Pass BS test (hours) | 80 | 50 | 30 |

What is claimed is:

1. Process for improving the corrosion resistance of a non-stick coating on a substrate comprising
(a) applying to said substrate a liquid composition comprising a heat resistant non-fluoropolymer binder and inorganic filler particles having an average particle size of no greater than about 2 micrometers to said substrate to obtain a base coat having a dry film thickness of at least about 10 micrometers,
(b) drying said composition to obtain said base coat, and
(c) applying said non-stick coating to said base coat to form a coated substrate.

2. The process of claim 1 which further includes baking said coated substrate.

3. The process of claim 1 wherein said base coat has a dry film thickness of at least about 12 micrometers.

4. The process of claim 1 wherein said base coat has a dry film thickness in the range of about 10 to about 35 micrometers.

5. The process of claim 1 wherein said base coat has a dry film thickness in the range of about 15 to about 30 micrometers.

6. The process of claim 1 wherein said base coat has a dry film thickness in the range of about 18 to about 22 micrometers.

7. The process of claim 1 wherein said liquid composition comprises an organic solvent.

8. The process of claim 1 wherein said non-fluoropolymer binder comprises a polymer selected form the group consisting of polyimide (PI), polyamideimide (PAI), polyether sulfone (PES), polyphenylene sulfide (PPS) and a mixture thereof.

9. The process of claim 8 wherein said non-fluoropolymer binder comprises polyamideimide (PAI) having a number average molecular weight of at least 15,000.

10. The process of claim 8 wherein said non-fluoropolymer binder comprises polyamideimide (PAI) having a number average molecular weight of in the range of about 15,000 to about 30,000.

11. The process of claim 8 wherein said non-fluoropolymer binder comprises polyamideimide (PAI) having a number average molecular weight of in the range of about 18,000 to about 25,000.

12. The process of claim 8 or 9 wherein said non-fluoropolymer binder comprises a combination of polyamideimide (PAI) and polyphenylene sulfide (PPS).

13. The process of claim 12 wherein said PAI is present in an amount greater than the amount of said PPS.

14. The process of claim 1 wherein said base coat is essentially free of fluoropolymer.

15. The process of claim 1 wherein said substrate is a metal substrate selected from the group consisting of aluminum, stainless, and carbon steel.

16. The process of claim 15 wherein said substrate is stainless steel.

17. The process of claim 1 wherein said inorganic filler particles have an average particle size of no greater than about 1 micron.

18. The process of claim 1 wherein said inorganic filler particles have an average particle size d₅₀ in the range of about 0.1 to about 2.0 micrometers

19. The process of claim 1 wherein said non-stick coating comprises a primer and a top coat and optionally one or more intermediate layers.

20. The process of claim 1 wherein said non-stick coating comprises a fluoropolymer.

21. The process of claim 1 wherein said inorganic filler is selected from a group consisting of inorganic nitrides, carbides, borides and oxides.

22. The process of claim 1 wherein said inorganic filler is selected from the group comprising inorganic oxides of titanium, aluminum, zinc, tin and a mixture thereof.

23. The process of claim 1 wherein said inorganic filler comprises titanium dioxide.

24. The process of claim 1 wherein said base coat contains a filler to binder ratio wherein the amount of binder present is equal to or greater than the amount of filler.

25. The process of claim 1 wherein said non-stick coating comprises a primer; an intermediate layer and a top layer.

26. The process of claims 1 which further includes grit blasting said substrate prior to applying said base coat.

27. The process of claim 1 wherein said coated substrate has a corrosion resistance in 10% boiling salt water of at least 24 hours according to BS 7049.

28. The process of claim 1 wherein said coated substrate has a corrosion resistance in 10% boiling salt water of at least 40 hours according to BS 7049.

29. The process of claim 1 wherein said structure coated substrate has a corrosion resistance in 10% boiling salt water of at least 56 hours according to BS 7049.

30. The process of claim 1 wherein said non-stick coating has an adherence to said substrate of at least about 2.0 Kg/cm.

31. The process of claim 1 wherein said non-stick coating has an adherence to said substrate of at least about 3.0 Kg/cm.

32. A corrosion resistant composition comprising polyamideimide (PAI) heat resistant polymer binder having a number average molecular weight of at least 15,000, a liquid solvent, and inorganic filler particles having an average particle size of no greater than about 2 micrometers.

33. The corrosion resistant composition of claim 32 wherein the composition also contains polyphenylene sulphide heat resistant polymer binder.

34. A corrosion resistant composition comprising organic solvent, soluble heat resistant non-fluoropolymer binder and insoluble particles of heat resistant non-fluoropolymer binder.

35. The corrosion resistant composition of claim 34 wherein said composition is essentially free of fluoropolymer.
